(19) United States
(12) Patent Application Publication
(10) Pub. No.: US 2016/0306242 A1
(43) Pub. Date: Oct. 20, 2016

(54) A LIQUID CRYSTAL DISPLAY DEVICE AND A LIQUID CRYSTAL DISPLAY PANEL THEREOF

(71) Applicant: Shenzhen China Star Optoelectronics Technology Co. Ltd., Shenzhen, Guamgdong (CN)

(72) Inventors: Cheng-hung CHEN, Shenzhen, Guangdong (CN); Zui WANG, Shenzhen, Guangdong (CN)

(73) Assignee: Shenzhen China Star Optoelectronics Technology Co. Ltd., Shenzhen, Guangdong (CN)

(21) Appl. No.: 14/758,230

(22) PCT Filed: Apr. 30, 2015
(86) PCT No.: PCT/CN2015/078002

§ 371 Date: Jun. 27, 2015

(30) Foreign Application Priority Data
Apr. 14, 2015 (CN) 2015101761574

(51) Int. Cl. G02F 1/1362; G02F 1/1333; G02F 1/1343; G02F 1/1368

(52) U.S. Cl. CPC G02F 1/136286; G02F 1/1368; G02F 1/133345; G02F 1/134309; G02F 1/13624; G02F 2201/121; G02F 2001/134345; G02F 2001/134354

(57) ABSTRACT

The present invention provides a liquid crystal display (LCD) panel including a top substrate, a bottom substrate, and a liquid crystal (LC) layer. The bottom substrate further includes an insulating layer between a bottom common electrode and a share sheet. A sub pixel is set on the insulating layer and next to the share sheet. The share sheet is electrically connected with A third thin film transistor (TFT) through a via and extends forward an end of the adjacent sub pixel. A share capacitance is set between the share sheet and the bottom common electrode of the adjacent sub pixel. A drain of the third TFT is coupled to the share capacitance so the two adjacent pixel units display solid color picture when short occurs between the adjacent sub pixel and the share capacitance. The detection is easy and effective so the yield is increased.

### BACKGROUND

1. Technical Field

The present invention relates to display field, and more particularly, to a liquid crystal display device and a liquid crystal display panel thereof.

2. Description of the Related Art

For correcting the color shift at the big viewing angle in the liquid crystal display (LCD) panel of vertical alignment (VA), it adopts pixel design of charge sharing. That is, the pixel has a main pixel and a sub pixel. In regular displaying mode, the charge gate opens and the sharing gate closes. The main pixel and the pixel electrode are charged to the same potential. Then, the charge gate closes and the share gate opens. The potential of the sub pixel is lower than that of the main pixel because of the share capacity (Cst3). The difference of the potential makes the orientations of the liquid crystal molecules different in two displaying regions so it corrects the color shift at the big viewing angle.

The product can adopt the pixel structure shown in FIGS. 1a and 1b. The share capacity (Cst3) is formed by an indium tin oxide (ITO) layer 2, a metal layer 3, and an insulating layer 4 therebetween. The ITO layer 2 is connected with the share TFT (T3) 6 through a via 5. The metal layer 3 is common electrode (Com).

The equivalent circuit diagram of the pixel circuit is shown in FIG. 1c. The ITO layer could remain in the manufacturing process. The short can occur because the ITO layer 2 of Cst3 is connected with the sub pixel electrode 7 (as the short connection 1 shown in FIG. 1b). It causes fail of the charge sharing. The sub pixel of the pixel unit having short is brighter than that of other pixel unit in grayscale. In practice, the detection is to open all gates at the same time, or open even gates or odd gates. All pixels are charged so the main pixel and the sub pixel have the same potential. This detection cannot investigate the short resulted from the connection of the ITO layer 2 and the sub pixel electrode 7 so the yield is decreased and the cost is increased.

### SUMMARY OF THE DISCLOSURE

The present invention provides a liquid crystal display (LCD) device and an LCD panel thereof. The technical problem that the short between the ITO layer and the sub pixel cannot be investigated so the yield is decreased and the cost is increased, can be solved.

For solving the aforementioned problem, the present invention adopts a technique that an LCD panel includes a top substrate, a bottom substrate, and a liquid crystal (LC) layer. The top substrate includes a top common electrode. The bottom substrate is set opposite to the top substrate and includes a plurality of data gates; a plurality of charge gates; a plurality of pixel units set next to each other; a plurality of share gates; and a plurality of bottom common electrodes. The LC layer is set between the top substrate and the bottom substrate. Each pixel unit includes a first thin film transistor (TFT) , a second TFT, and a third TFT set on a plurality of bottom substrates respectively; a main pixel; a sub pixel set next to the main pixel 234; and a share sheet set between the main pixel and the sub pixel. A gate of the first TFT is coupled to the charge gate, a source of the first TFT is coupled to the data gate, and a drain of the first TFT is coupled to the main pixel. A gate of the second TFT is coupled to the charge gate, a source of the second TFT is coupled to the data gate, and a drain of the second TFT is coupled to the sub pixel. A gate of the third TFT is coupled to the share gate, and a source of the third TFT is coupled to a drain of the second TFT, wherein the bottom substrate further includes an insulating layer between the bottom common electrode and the share sheet. The sub pixel is set on the insulating layer and next to the share sheet. The share sheet is electrically connected with the third TFT through a via and extends forward an end of the adjacent sub pixel. A share capacitance is set between the share sheet and the bottom common electrode of the adjacent sub pixel. A drain of the third TFT is coupled to the share capacitance so the two adjacent pixel units display solid color picture when short occurs between the adjacent sub pixel and the share capacitance. The bottom common electrode includes an extensive part, the data gate is electrically connected with the source of the first TFT through the extensive part, and the extensive part and a connective gate are alternatively stacked.

A half of the share sheet is set on an end of the sub pixel and the other half of the share sheet extends to an end of the adjacent sub pixel.

⅕ of the share sheet is set on an end of the sub pixel and ⅘ of the share sheet extends to an end of the adjacent sub pixel.

The extensive part is alternatively stacked on a top of the connective gate.

The extensive part is alternatively stacked on a bottom of the connective gate.

For solving the aforementioned problem, the present invention adopts a technique that an LCD panel includes a top substrate, a bottom substrate, and a liquid crystal (LC) layer. The top substrate includes a top common electrode. The bottom substrate is set opposite to the top substrate and includes a plurality of data gates; a plurality of charge gates; a plurality of pixel units set next to each other; a plurality of share gates; and a plurality of bottom common electrodes. The LC layer is set between the top substrate and the bottom substrate. Each pixel unit includes a first thin film transistor (TFT), a second TFT, and a third TFT set on a plurality of bottom substrates respectively; a main pixel; a sub pixel set next to the main pixel 234; and a share sheet set between the main pixel and the sub pixel. A gate of the first TFT is coupled to the charge gate, a source of the first TFT is coupled to the data gate, and a drain of the first TFT is coupled to the main pixel. A gate of the second TFT is coupled to the charge gate, a source of the second TFT is coupled to the data gate, and a drain of the second TFT is coupled to the sub pixel. A gate of the third TFT is coupled to the share gate, and a source of the third TFT is coupled to a drain of the second TFT, wherein the bottom substrate further includes an insulating layer between the bottom common electrode and the share sheet. The sub pixel is set on the insulating layer and next to the share sheet. The share sheet is electrically connected with the third TFT through a via and extends forward an end of the adjacent sub pixel. A share capacitance is set between the share sheet and the bottom common electrode of the adjacent sub pixel. A drain of the third TFT is coupled to the share capacitance so the two adjacent pixel units display solid color picture when short occurs between the adjacent sub pixel and the share capacitance.

A half of the share sheet is set on an end of the sub pixel and the other half of the share sheet extends to an end of the adjacent sub pixel.

⅕ of the share sheet is set on an end of the sub pixel and ⅘ of the share sheet extends to an end of the adjacent sub pixel.

The bottom common electrode includes an extensive part, the data gate is electrically connected with the source of the first TFT through the extensive part, and the extensive part and a connective gate are alternatively stacked.

The extensive part is alternatively stacked on a top of the connective gate.

The extensive part is alternatively stacked on a bottom of the connective gate.

For solving the aforementioned problem, the present invention adopts another technique that an LCD device including the aforementioned LCD panel.

Comparing to the conventional technique, the sub pixel of the present LCD device and the present LCD panel is set on the insulating layer and next to the share sheet. The share sheet is electrically connected with the third TFT through a via and extends forward an end of the adjacent sub pixel. A share capacitance is set between the share sheet and the bottom common electrode of the adjacent sub pixel. A drain of the third TFT is coupled to the share capacitance so the two adjacent pixel units display solid color picture when short occurs between the adjacent sub pixel and the share capacitance. The detection is easy and effective so the yield is increased.

### BRIEF DESCRIPTION OF THE DRAWINGS

The accompanying drawings are included to provide easy understanding of the application, are incorporated herein and constitute a part of this specification. The drawings illustrate embodiments of the application and, together with the description, serve to illustrate the principles of the application.

FIG. 1a is a top view of a pixel structure of a liquid crystal display (LCD) panel of VA.

FIG. 1b is an equivalent circuit diagram of a portion of the LCD panel of VA.

FIG. 1c is a schematic view of a partial structure of the LCD panel of VA.

FIG. 2 is a top view of a partial structure of an LCD panel in accordance with an embodiment of the present invention.

FIG. 3 is a top view of the LCD panel of FIG. 2.

FIG. 4 is an equivalent circuit diagram of a pixel unit of the LCD panel in accordance with an embodiment of the present invention.

FIG. 5 is an equivalent circuit diagram of two adjacent sub pixels in accordance with an embodiment of the LCD panel of the present invention.

FIG. 6 is a top view of a main pixel structure of the LCD panel in accordance with an embodiment of the present invention.

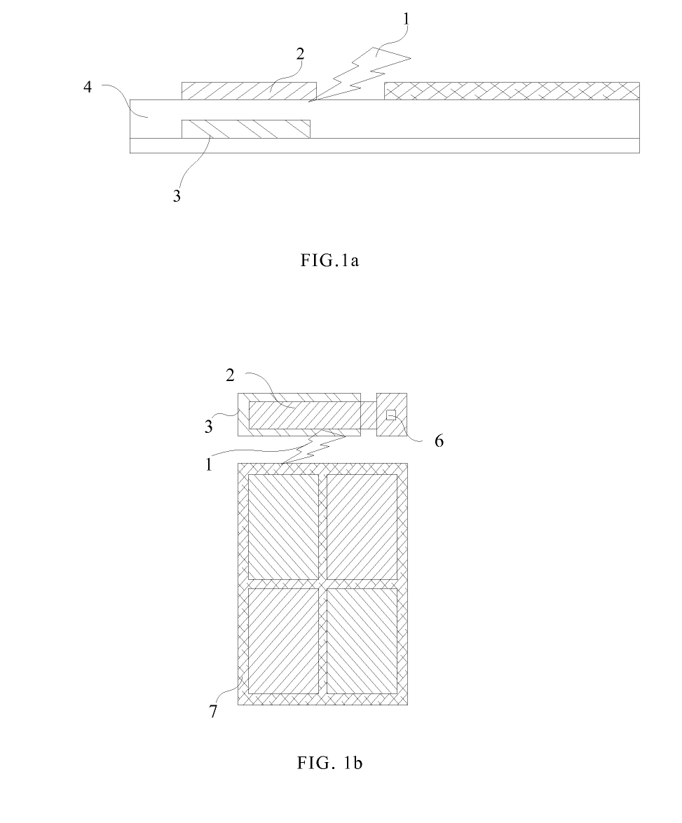

### DESCRIPTION OF THE PREFERRED EMBODIMENTS

To better and concisely explain the disclosure, the same name or the same reference number given or appeared in different paragraphs or figures along the specification should has the same or equivalent meanings while it is once defined anywhere of the disclosure.

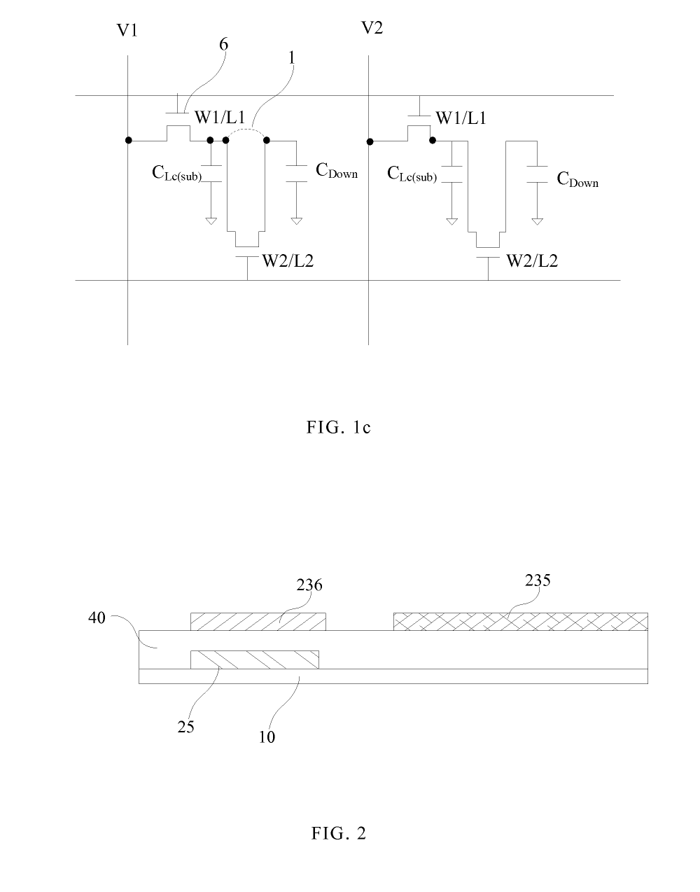

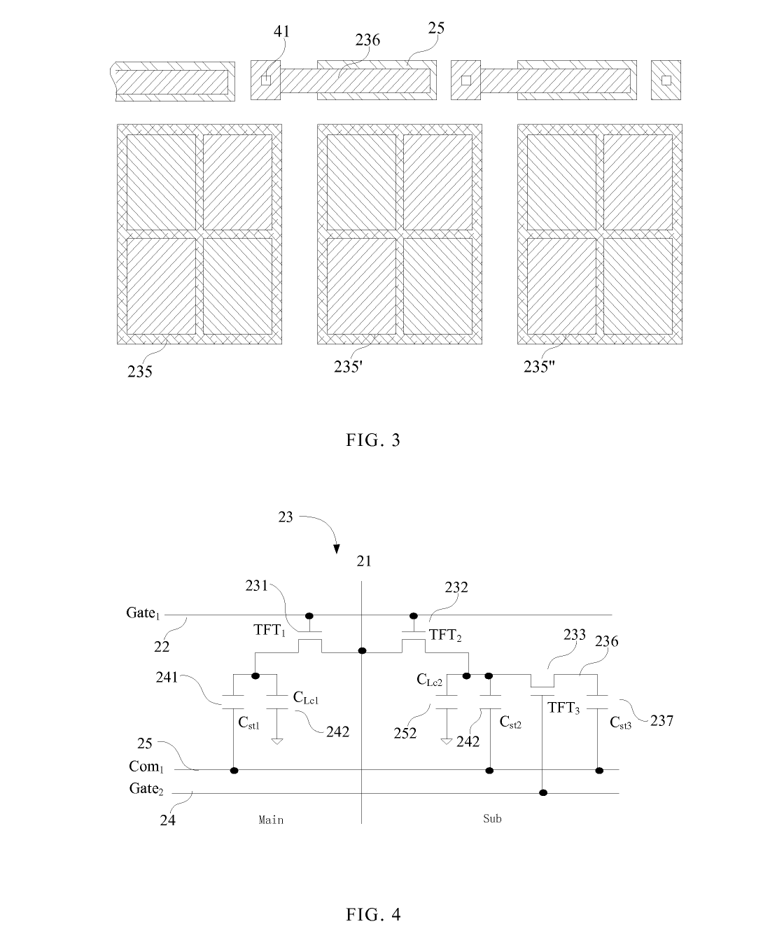

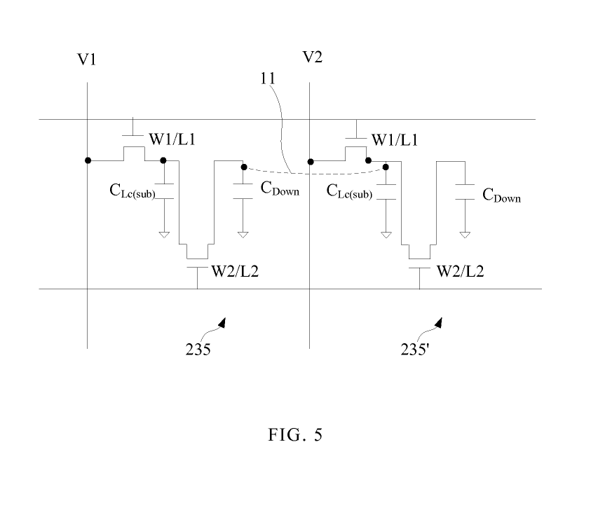

Referring FIGS. 2-5 together, FIG. 2 is a schematic view of a partial structure of a liquid crystal display (LCD) panel in accordance with an embodiment of the present invention, FIG. 3 is a top view of the LCD panel of FIG. 2, FIG. 4 is an equivalent circuit diagram of a pixel unit of the LCD panel, and FIG. 5 is an equivalent circuit diagram of two adjacent sub pixels of the LCD panel.

The LCD panel includes a top substrate (not shown here), a bottom substrate 10, and a liquid crystal (LC) layer (not shown here). The LC layer is set between the top substrate and the bottom substrate 10.

Referring FIG. 4, there is a top common electrode (not shown here) set on the top substrate. The bottom substrate 10 is set opposite to the top substrate. There are a plurality of data gates 21, a plurality of charge gates 22, a plurality of pixel units 23 set next to each other, a plurality of share gates 24, and a plurality of bottom common electrodes 25 on the bottom substrate 10. Each pixel unit 23 includes a first thin film transistor (TFT) 231, a second TFT 232, and a third TFT 233 set on a plurality of bottom substrates 10 respectively; a main pixel 234; a sub pixel 235 set next to the main pixel 234; and a share sheet 236 set between the main pixel 234 and the sub pixel 235. The gate of the first TFT 231 is coupled to the charge gate 22, the source thereof is coupled to the data gate 21, and the drain thereof is coupled to the main pixel 234. The gate of the second TFT 232 is coupled to the charge gate 22, the source thereof is coupled to the data gate 21, and the drain thereof is coupled to the sub pixel 235. The gate of the third TFT 233 is coupled to the share gate 24, and the source thereof is coupled to the drain of the second TFT 232, wherein there are a first storage capacitance (Cₛₜ₁) 241 formed between the main pixel 234 and the top common electrode, a first LC capacitance (C_{1c1}) 251 formed between the main pixel 234 and the bottom common electrode 25, a second storage capacitance (Cₛₜ₂) 242 formed between the sub pixel 235 and the top common electrode, and a second LC capacitance (C_{1c2}) 252 formed between the sub pixel 235 and the bottom common electrode 25.

Referring FIGS. 2 and 3, the bottom substrate 10 further includes an insulating layer 40 between the bottom common electrode 25 and the share sheet 236. The sub pixel 235 is set on the insulating layer 40 and next to the share sheet 236. The share sheet 236 is electrically connected with the third TFT 233 through a via 41 and extends forward an end of the adjacent sub pixel 235′. A share capacitance 237 (Cₛₜ₃) is set between the share sheet 236 and the bottom common electrode 25 of the adjacent sub pixel 235′. A drain of the third TFT 233 is coupled to the share capacitance 237 (Cₛₜ₃) so the two adjacent pixel units 23 display solid color picture when short occurs between the adjacent sub pixel 235′ and the share capacitance 237 (Cₛₜ₃). FIG. 5 is the equivalent circuit diagram and dotted line 11 represents the short.

A half of the share sheet 236 of the present invention is set on an end of the sub pixel 235 and the other half of the share sheet 236 extends to an end of the adjacent sub pixel 235′. It can be that ⅓ of the share sheet 236 is set on an end of the sub pixel 235 and ⅔ of the share sheet 236 extends to an end of the adjacent sub pixel 235′ as well. It further can be that ⅕ of the share sheet 236 is set on an end of the sub pixel 235 and ⅘ of the share sheet 236 extends to an end of the adjacent sub pixel 235′.

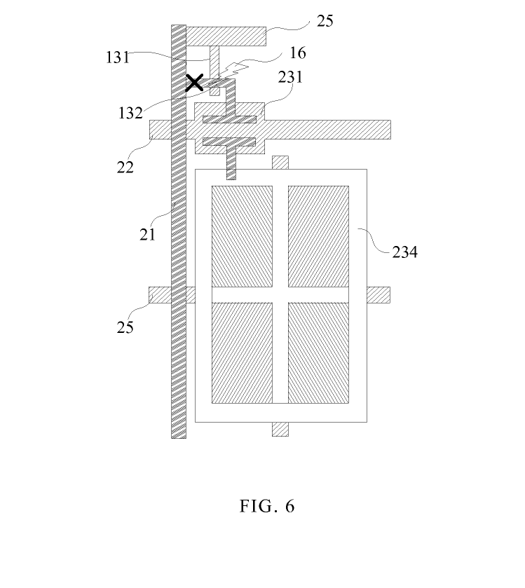

FIG. 6 is a top view of a main pixel structure of the LCD panel. In another embodiment, the bottom common electrode 25 includes an extensive part 131. The data gate 21 is electrically connected with a source of the first TFT 231 through the extensive part 131. The extensive part 131 and a connective gate 132 are alternatively stacked. The extensive part 131 is alternatively stacked on the top or the bottom of the data gate 21. Specifically, the extensive part 131 extends from the bottom common electrode 25 toward the source of the first TFT 231. The end of the extensive part 131 is adjacent to the source of the first TFT 231 and is set on the top or the bottom of the connective gate 132 between the data gate 21 and the source of the first TFT 231. The connective gate 132 is insulating from the extensive part 131. When darkening, the connective gate 132 between the data gate 21 and the source of the first TFT 231 is disconnected (represented by X in FIG. 6) and the extensive part 131 is in electrical conduction with the connective gate 132 of the source of the first TFT 231 by laser (represented by 16 in FIG. 6). Voltage of the main pixel 234 is the same as that of the bottom common electrode 25 and further the same as that of the top common electrode so the corresponding LC molecule is not twisted and the darkening is achieved. It is easy for operation and darkening to avoid the small bright dot and the product repair rate and the yield are increased.

The present invention further provides an LCD device including the aforementioned LCD panel.

The sub pixel 235 is set on the insulating layer 40 and next to the share sheet 236. The share sheet 236 is electrically connected with the third TFT 233 through the via 41 and extends forward an end of the adjacent sub pixel 235′. A share capacitance 237 (Cₛₜ₃) is set between the share sheet 236 and the bottom common electrode 25 of the adjacent sub pixel 235′. A drain of the third TFT 233 is coupled to the share capacitance 237 (Cₛₜ₃) so the two adjacent pixel units 23 display solid color picture when short occurs between the adjacent sub pixel 235′ and the share capacitance 237 (Cₛₜ₃). The detection is easy and effective so the yield is increased.

It will be apparent to those having ordinary skill in the art that various modifications and variations can be made to the devices in accordance with the present disclosure without departing from the scope or spirit of the disclosure. In view of the foregoing, it is intended that the present disclosure covers modifications and variations of this disclosure provided they fall within the scope of the following claims and their equivalents.

What is claimed is:

1. A liquid crystal display (LCD) panel, comprising:
a top substrate, comprising a top common electrode;
a bottom substrate set opposite to the top substrate, comprising :
a plurality of data gates;
a plurality of charge gates;
a plurality of pixel units set next to each other;
a plurality of share gates; and
a plurality of bottom common electrodes;
a liquid crystal (LC) layer set between the top substrate and the bottom substrate;
wherein each pixel unit comprises a first thin film transistor (TFT) , a second TFT, and a third TFT set on a plurality of bottom substrates respectively; a main pixel; a sub pixel set next to the main pixel 234; and a share sheet set between the main pixel and the sub pixel;
a gate of the first TFT is coupled to the charge gate, a source of the first TFT is coupled to the data gate, and a drain of the first TFT is coupled to the main pixel; a gate of the second TFT is coupled to the charge gate, a source of the second TFT is coupled to the data gate, and a drain of the second TFT is coupled to the sub pixel; a gate of the third TFT is coupled to the share gate, and a source of the third TFT is coupled to a drain of the second TFT;
wherein the bottom substrate further comprises an insulating layer between the bottom common electrode and the share sheet, the sub pixel is set on the insulating layer and next to the share sheet, the share sheet is electrically connected with the third TFT through a via and extends forward an end of the adjacent sub pixel, a share capacitance is set between the share sheet and the bottom common electrode of the adjacent sub pixel, a drain of the third TFT is coupled to the share capacitance so the two adjacent pixel units display solid color picture when short occurs between the adjacent sub pixel and the share capacitance,
the bottom common electrode comprises an extensive part, the data gate is electrically connected with the source of the first TFT through the extensive part, and the extensive part and a connective gate are alternatively stacked.

2. The LCD panel of claim 1, wherein a half of the share sheet is set on an end of the sub pixel and the other half of the share sheet extends to an end of the adjacent sub pixel.

3. The LCD panel of claim 1, wherein ⅕ of the share sheet is set on an end of the sub pixel and ⅘ of the share sheet extends to an end of the adjacent sub pixel.

4. The LCD panel of claim 2, wherein the extensive part is alternatively stacked on a top of the connective gate.

5. The LCD panel of claim 1, wherein the extensive part is alternatively stacked on a bottom of the connective gate.

6. A liquid crystal display (LCD) panel, comprising:
a top substrate, comprising a top common electrode;
a bottom substrate set opposite to the top substrate, comprising:
a plurality of data gates;
a plurality of charge gates;
a plurality of pixel units set next to each other;
a plurality of share gates; and
a plurality of bottom common electrodes;
a liquid crystal (LC) layer set between the top substrate and the bottom substrate;
wherein each pixel unit comprises a first thin film transistor (TFT) , a second TFT, and a third TFT set on a plurality of bottom substrates respectively; a main pixel; a sub pixel set next to the main pixel 234; and a share sheet set between the main pixel and the sub pixel;
a gate of the first TFT is coupled to the charge gate, a source of the first TFT is coupled to the data gate, and a drain of the first TFT is coupled to the main pixel; a gate of the second TFT is coupled to the charge gate, a source of the second TFT is coupled to the data gate, and a drain of the second TFT is coupled to the sub pixel; a gate of the third TFT is coupled to the share gate, and a source of the third TFT is coupled to a drain of the second TFT;
wherein the bottom substrate further comprises an insulating layer between the bottom common electrode and the share sheet, the sub pixel is set on the insulating layer and next to the share sheet, the share sheet is electrically connected with the third TFT through a via and extends forward an end of the adjacent sub pixel, a share capacitance is set between the share sheet and the bottom common electrode of the adjacent sub pixel, a drain of the third TFT is coupled to the share capacitance so the two adjacent pixel units display solid color picture when short occurs between the adjacent sub pixel and the share capacitance.

7. The LCD panel of claim 6, wherein a half of the share sheet is set on an end of the sub pixel and the other half of the share sheet extends to an end of the adjacent sub pixel.

8. The LCD panel of claim 6, wherein ⅕ of the share sheet is set on an end of the sub pixel and ⅘ of the share sheet extends to an end of the adjacent sub pixel.

9. The LCD panel of claim 6, wherein the bottom common electrode comprises an extensive part, the data gate is electrically connected with the source of the first TFT through the extensive part, and the extensive part and a connective gate are alternatively stacked

10. The LCD panel of claim 9, wherein the extensive part is alternatively stacked on a top of the connective gate.

11. The LCD panel of claim 9, wherein the extensive part is alternatively stacked on a bottom of the connective gate.

12. A liquid crystal display (LCD) device, comprising the LCD panel of claim 11.
